(19) United States
(12) Patent Application Publication
(10) Pub. No.: US 2026/0371011 A1
(43) Pub. Date: Nov. 19, 2026

(54) Sound-Producing Device

(71) Applicant: AAC Microtech (Changzhou) Co., Ltd., Changzhou City (CN)

(72) Inventors: Zhiwei Zhong, Changzhou (CN); Xiaodong Liu, Changzhou (CN); Xin Jin, Changzhou (CN); Wei Song, Changzhou (CN)

(21) Appl. No.: 19/324,060

(22) Filed: Sep. 9, 2025

Related U.S. Application Data
(63) Continuation of application No. PCT/CN2025/095187, filed on May 15, 2025.

(51) Int. Cl. H04R 9/02; H04R 1/02; H04R 1/06; H04R 7/18; H04R 9/04; H04R 9/06

(52) U.S. Cl. CPC H04R 9/025; H04R 1/06; H04R 7/18; H04R 9/045; H04R 9/063; H04R 1/02; H04R 2400/11

(57) ABSTRACT

The invention provides a speaker device which has a frame; a vibration system with a diaphragm and a voice coil; and a magnetic circuit system with a yoke, a main magnet stacked and fixed to a side of the yoke close to the diaphragm, and an auxiliary magnet. The speaker device further includes an elastic support member having a first connecting portion, a second connecting portion, and an elastic portion. The first connecting portion is fixed to a side of the auxiliary magnet away from the diaphragm along the vibration direction, the second connecting portion is fixed to a side of the diaphragm close to the magnetic circuit system along the vibration direction and is electrically connected to the voice coil. Compared with related technology, the speaker device of the invention has a long service life, saves installation space, and has excellent acoustic performance.

### TECHNICAL FIELD

The present invention relates to the field of electroacoustic transducer technology, particularly to a sound-producing device.

### BACKGROUND

With the development of electronic technology, sound-producing devices have been widely used in small electronic devices such as mobile phones, game consoles, and tablets, mainly providing sound playback for these small electronic devices, such as music playback, game sound playback, and video volume playback.

A sound-producing device includes a frame, a vibration system fixed to the frame, and a magnetic circuit system driving the vibration system to vibrate. The vibration system includes a diaphragm fixed to the frame and a voice coil driving the diaphragm to vibrate and produce sound. Of course, to enable the vibration system to stably vibrate and produce sound as well as receive external electrical energy, the sound-producing device also includes an elastic connecting structure with one end fixed to the frame and another end fixed to and electrically connected to the voice coil.

However, in the related technology, the elastic arm portions of the elastic connecting structure in sound-producing devices are all planar structural designs, which rely on excess line length arm shear deformation to maintain connection during vibration. The planar structure's deforming arm not only has internal stress but also shear stress from deformation, which not only occupies a large amount of planar space in the sound-producing device but also significantly reduces the service life of the elastic connecting structure.

Therefore, it is necessary to provide a new sound-producing device to solve the above technical problems.

### SUMMARY

At least one of the objects of the present invention is to provide a sound generator with long service life, space-saving installation, and excellent acoustic performance.

To achieve the above purposes, the present invention provides a sound-producing device, comprising:
a frame;
a vibration system comprising a diaphragm fixed to the frame and at least two spaced voice coils deployed to drive the diaphragm to vibrate and produce sound;
a magnetic circuit system comprising a lower yoke fixed to a side of the frame away from the vibration system and a magnet unit stacked and fixed to a side of the lower yoke close to the vibration system, wherein a number of the magnet units is equal to a number of the voice coils, each magnet unit comprising a main magnet and an auxiliary magnet surrounding and spaced from the main magnet to form a magnetic gap; each voice coil being inserted into one magnetic gap;
a plurality of elastic support members, with one elastic support member being disposed between each adjacent two voice coils; wherein
each elastic support member comprises a first connecting portion, a second connecting portion, a third connecting portion, a first elastic portion and a second elastic portion;
the first connecting portion and the second connecting portion are respectively located at opposite sides of the magnetic circuit system along a vibration direction of the vibration system, the third connecting portion and the first connecting portion are located at a same side of the magnetic circuit system and spaced apart from each other; the first connecting portion and the third connecting portion are respectively fixed to a side of corresponding auxiliary magnets away from the diaphragm, the second connecting portion is fixed to a side of the diaphragm close to the magnetic circuit system and electrically connected to the voice coils;
the first elastic portion and the second elastic portion are respectively located between corresponding adjacent auxiliary magnets and spaced from the auxiliary magnets, two ends of the first elastic portion are respectively fixed to the first connecting portion and the second connecting portion, two ends of the second elastic portion are respectively fixed to the third connecting portion and the second connecting portion;
the lower yoke comprises relief grooves penetrating therethrough at positions corresponding to the first connecting portion and the third connecting portion, such that the first connecting portion and the third connecting portion of each elastic support member are exposed.

Further, the first elastic portion and the second elastic portion are both U-shaped structures, and the first elastic portion and the second elastic portion of each elastic support member have openings oriented facing each other.

Further, the second connecting portion of each elastic support member comprises a first fixing portion connected to the first connecting portion, a second fixing portion connected to the third connecting portion, and a third fixing portion connecting the first fixing portion and the second fixing portion, both ends of one of the voice coils adjacent to the elastic support member are connected to the first fixing portion, both ends of another voice coil adjacent to the elastic support member are connected to the second fixing portion.

The first elastic portion of each elastic support member extends from the first connecting portion along the vibration direction by bending to the second connecting portion and forms a fixed connection with the second connecting portion, the second elastic portion of each elastic support member extends from the third connecting portion along the vibration direction by bending to the second connecting portion and forms a fixed connection with the second connecting portion.

Further, the frame is rectangular; multiple voice coils are arranged sequentially along either a long axis direction or a short axis direction of the frame.

Further, the auxiliary magnet of each magnet unit is ring-shaped, the auxiliary magnets of adjacent magnet units are spaced apart from each other; or, the auxiliary magnets of adjacent magnet units are connected as an integral structure.

Further, the auxiliary magnet of each magnet unit is ring-shaped, adjacent auxiliary magnets are connected as an integral structure through magnetic connecting portions; the first connecting portion and the third connecting portion of each elastic support member are respectively fixed to the magnetic connecting portions between corresponding adjacent auxiliary magnets.

Further, the magnetic circuit system further comprises ring-shaped upper yokes equal in number to the auxiliary magnets, each upper yoke being stacked and fixed to a side of one auxiliary magnet close to the diaphragm; the first elastic portion and the second elastic portion of each elastic support member are respectively located between adjacent upper yokes and spaced from the adjacent upper yokes.

Further, multiple upper yokes are spaced apart from each other; or, the multiple upper yokes are connected sequentially as an integral structure.

Further, adjacent upper yokes are connected as an integral structure through magnetic yoke connecting portions; each yoke connecting portion comprises avoidance holes penetrating therethrough at positions corresponding to the second connecting portion.

Further, the sound-producing device further comprises sealing covers equal in number to the relief grooves; each sealing cover comprises a seal body and a limiting portion formed by bending and extending from a side of the seal body away from the main magnet toward the diaphragm; the seal body is disposed in the relief groove, the limiting portion is fixed between adjacent auxiliary magnets.

Further, the first connecting portion of each elastic support member comprises a first conductive member fixed to an end of the first elastic portion away from the second connecting portion and a first plastic seal injection-molded on the first conductive member and fixed to the auxiliary magnet, the first conductive member being electrically connected to the first elastic portion; the third connecting portion of each elastic support member comprises a second conductive member fixed to an end of the second elastic portion away from the second connecting portion and a second plastic seal injection-molded on the second conductive member and fixed to the auxiliary magnet, the second conductive member being electrically connected to the second elastic portion.

Compared with the related technology, the sound-producing device of the present invention places the elastic support members between adjacent voice coils, and specifies that each elastic support member includes a first connecting portion, a second connecting portion, a third connecting portion, a first elastic portion and a second elastic portion. The first connecting portion and the second connecting portion are respectively located at opposite sides of the magnetic circuit system along the vibration direction of the vibration system, the third connecting portion and the first connecting portion are located at the same side of the magnetic circuit system and spaced apart from each other. The first connecting portion and the third connecting portion are respectively fixed to a side of corresponding auxiliary magnets away from the diaphragm, the second connecting portion is fixed to a side of the diaphragm close to the magnetic circuit system and electrically connected to the voice coils. Two ends of the first elastic portion are respectively fixed to the first connecting portion and the second connecting portion, two ends of the second elastic portion are respectively fixed to the third connecting portion and the second connecting portion; the first elastic portion and the second elastic portion are respectively located between corresponding adjacent auxiliary magnets and spaced from the auxiliary magnets. Through this three-dimensional structure of the elastic support members, connection can be maintained using elastic deformation of the three-dimensional structure during vibration, and during elastic deformation there is only internal strain force. Compared with planar elastic connecting structures, the stress is reduced, thereby greatly improving the service life of the elastic support members. Moreover, compared with planar elastic connecting structures, it significantly reduces the planar space occupied in the sound-producing device, providing extra space for installing other components, mainly providing more installation space for the magnetic circuit system, to enhance the acoustic performance of the sound-producing device. Meanwhile, adopting a multi-voice coil structure can also improve the utilization efficiency of the magnetic circuit system, further enhancing the acoustic performance of the sound-producing device.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a sound-producing device provided by an embodiment of the present invention;

FIG. 2 is an internal structural view of the sound-producing device in FIG. 1;

FIG. 3 is an exploded structural view of the sound-producing device in FIG. 1;

FIG. 4 is a cross-sectional view of the sound-producing device taken along line A-A in FIG. 1;

FIG. 5 is a cross-sectional view of the sound-producing device taken along line B-B in FIG. 1;

FIG. 6 is an isometric view of an elastic support member in the sound-producing device in FIG. 1;

FIG. 7 is an internal structural view of a sound-producing device provided by a second embodiment of the present invention;

FIG. 8 is an isometric view of a sound-producing device provided by a third embodiment of the present invention;

FIG. 9 is an exploded structural view of the sound-producing device provided by the third embodiment of the present invention;

FIG. 10 is a cross-sectional view of the sound-producing device taken along line C-C in FIG. 8.

### DETAILED DESCRIPTION OF THE EMBODIMENTS

The following will be taken in conjunction with the accompanying drawings of embodiments of the present invention, The technical scheme in the embodiments of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

### Embodiment 1

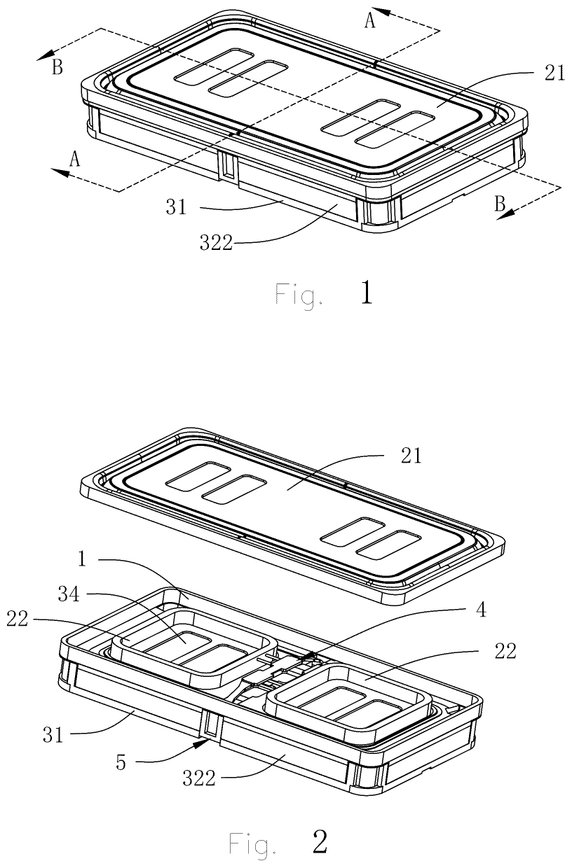

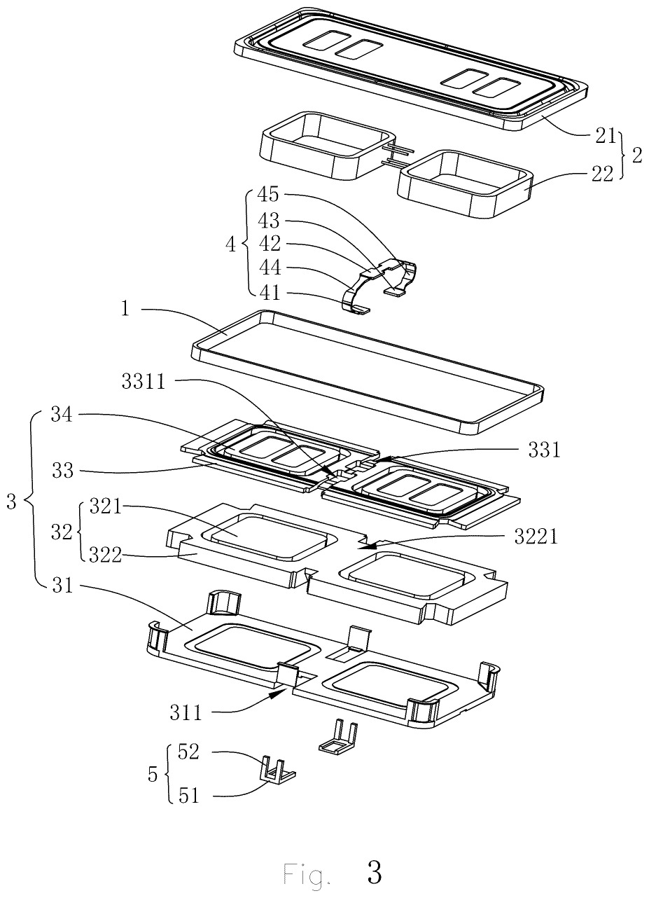

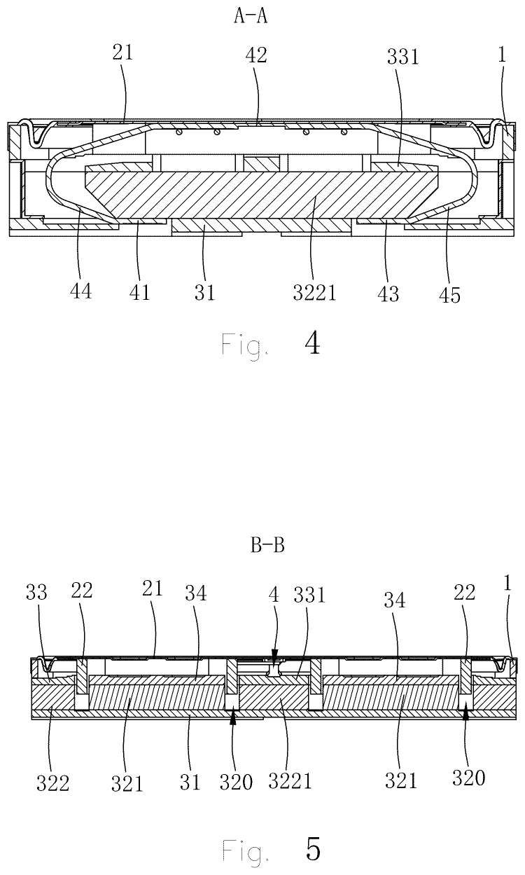

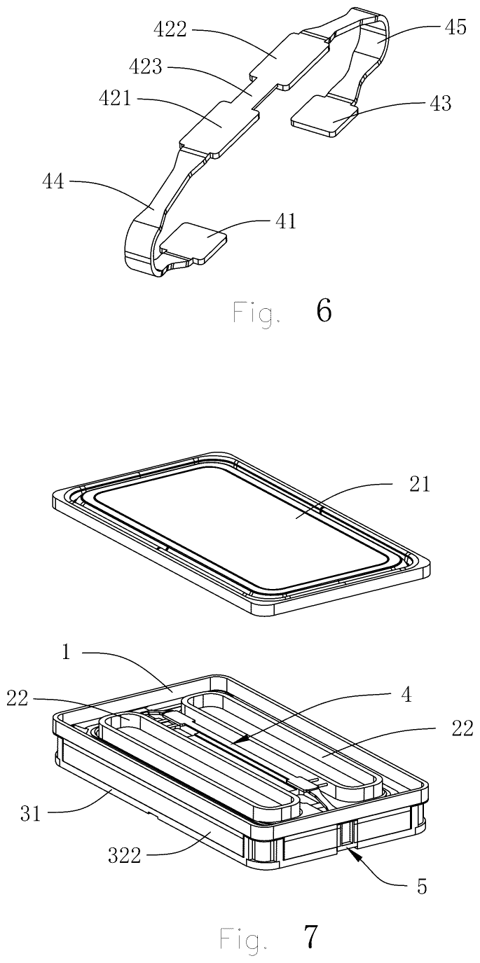

The present invention embodiment provides a sound-producing device 100. Referring to FIGS. 1 to 6, it includes a frame 1, a vibration system 2, a magnetic circuit system 3, and elastic support members 4.

The frame 1 is rectangular. Of course, according to actual needs, the frame 1 can also be designed in other shapes, such as circular, elliptical, trapezoidal, etc.

The vibration system 2 includes a diaphragm 21 fixed to the frame 1 and at least two spaced voice coils 22 deployed to drive the diaphragm 21 to vibrate and produce sound. In this embodiment, there are two voice coils 22. Of course, according to actual needs, the voice coils 22 can also be designed as three, four, five, etc.; multiple voice coils 22 are arranged sequentially along the long axis direction of the frame 1.

The magnetic circuit system 3 includes a lower yoke 31 fixed to a side of the frame 1 away from the vibration system 2 and magnet units 32 stacked and fixed to a side of the lower yoke 31 close to the vibration system 2. The number of magnet units 32 is equal to the number of voice coils 22. Each magnet unit 32 includes a main magnet 321 and an auxiliary magnet 322 surrounding and spaced from the main magnet 321 to form a magnetic gap 320; each voice coil 22 is inserted into one magnetic gap 320.

In this embodiment, the auxiliary magnet 322 of each magnet unit 32 is ring-shaped; the auxiliary magnets 322 of adjacent magnet units 32 are connected as an integral structure, which facilitates their installation and production. Specifically, the auxiliary magnets 322 of adjacent magnet units 32 are connected as an integral structure through magnetic connecting portions 3221. Of course, according to actual needs, the auxiliary magnets 322 of adjacent magnet units 32 can also be spaced apart from each other.

The magnetic circuit system 3 also includes pole pieces 34 equal in number to the main magnets 321, with each pole piece 34 being stacked and fixed to a side of one main magnet 321 close to the diaphragm 21.

The magnetic circuit system 3 also includes ring-shaped upper yokes 33 equal in number to the auxiliary magnets 322, with each upper yoke 33 being stacked and fixed to a side of one auxiliary magnet 322 close to the diaphragm 21.

In this embodiment, multiple upper yokes 33 are connected sequentially as an integral structure; specifically, adjacent upper yokes 33 are connected as an integral structure through yoke connecting portions 331, which are magnetic, facilitating their installation and production. Of course, according to actual needs, multiple upper yokes 33 can also be spaced apart from each other.

One elastic support member 4 is disposed between each adjacent pair of voice coils 22, meaning the number of elastic support members 4 equals the number of voice coils 22 minus one.

Each elastic support member 4 comprises a first connecting portion 41, a second connecting portion 42, a third connecting portion 43, a first elastic portion 44, and a second elastic portion 45; the first connecting portion 41 and the second connecting portion 42 are respectively located at opposite sides of the magnetic circuit system 3 along the vibration direction of the vibration system 2, the third connecting portion 43 and the first connecting portion 41 are located at the same side of the magnetic circuit system 3 and spaced apart from each other; the first connecting portion 41 and the third connecting portion 43 are respectively fixed to a side of corresponding adjacent auxiliary magnets 322 away from the diaphragm 21, the second connecting portion 42 is fixed to a side of the diaphragm 21 close to the magnetic circuit system 3 and electrically connected to the voice coils 22; the first elastic portion 44 and the second elastic portion 45 are respectively located between corresponding adjacent auxiliary magnets 322 and spaced from the auxiliary magnets 322, two ends of the first elastic portion 44 are respectively fixed to the first connecting portion 41 and the second connecting portion 42, two ends of the second elastic portion 45 are respectively fixed to the third connecting portion 43 and the second connecting portion 42. This configuration allows the elastic support member 4 to be designed as a 3D stereoscopic structure.

In this embodiment, both the first elastic portion 44 and the second elastic portion 45 are U-shaped structures, which include V-shaped and C-shaped structures, but are not limited to these. Any arc-shaped or similar arc-shaped structure that can provide elastic opening and closing along the vibration direction is suitable. That is, in this embodiment, the U-shaped structures of the first elastic portion 44 and the second elastic portion 45 can connect the first connecting portion 41 and the second connecting portion 42 that are not in the same plane, as well as connect the third connecting portion 43 and the second connecting portion 42 that are not in the same plane, while providing elastic support force.

The first elastic portion 44 of each elastic support member 4 extends from the first connecting portion 41 along the vibration direction by bending to the second connecting portion 42 and forms a fixed connection with the second connecting portion 42, and the second elastic portion 45 of each elastic support member 4 extends from the third connecting portion 43 along the vibration direction by bending to the second connecting portion 42 and forms a fixed connection with the second connecting portion 42.

The lower yoke 31 comprises relief grooves 311 penetrating therethrough at positions corresponding to the first connecting portion 41 and the third connecting portion 43, such that the first connecting portion 41 and the third connecting portion 43 of each elastic support member 4 are exposed. This design facilitates electrical connection between the first connecting portion 41 and the second connecting portion 42 of each elastic support member 4 with external devices, such as connection to an external power supply to power the voice coils 22.

The openings of the first elastic portion 44 and the second elastic portion 45 of each elastic support member 4 are oriented facing each other. This design reduces the space occupied by the elastic support member 4.

The second connecting portion 42 of each elastic support member 4 comprises a first fixing portion 421 connected to the first connecting portion 41, a second fixing portion 422 connected to the third connecting portion 43, and a third fixing portion 423 connecting the first fixing portion 421 and the second fixing portion 422. Both ends of one voice coil 22 adjacent to the elastic support member 4 are connected to the first fixing portion 421, and both ends of another voice coil 22 adjacent to the elastic support member 4 are connected to the second fixing portion 422; the length of the third fixing portion 423 along the long axis direction of the frame 1 is smaller than the lengths of both the first fixing portion 421 and the second fixing portion 422 along the long axis direction of the frame 1. This design facilitates the connection between the second connecting portion 42 and adjacent voice coils while avoiding material waste.

The first connecting portion 41 and the third connecting portion 43 of each elastic support member 4 are respectively fixed to the magnetic connecting portions 3221 between corresponding adjacent auxiliary magnets 422, and the magnetic connecting portions 3221 are spaced from the first elastic portion 44 and the second elastic portion 45 of the elastic support member 4 at opposite sides along the vibration direction. This design reduces the space occupied by the elastic support member 4 while preventing the first elastic portion 44 and the second elastic portion 45 from touching the magnetic circuit system 3 during elastic deformation, which would affect the acoustic performance of the sound-producing device 100, and facilitates the fixed installation of the first connecting portion 41 and the third connecting portion 43 of the elastic support member 4.

The first elastic portion 44 and the second elastic portion 45 of each elastic support member 4 are respectively located between adjacent upper yokes 33 and spaced from the adjacent upper yokes 33, and correspondingly spaced from the yoke connecting portions 331, specifically located at opposite sides of the yoke connecting portions 331 along the vibration direction. This design reduces the space occupied by the elastic support member 4 while preventing the first elastic portion 44 and the second elastic portion 45 from touching the magnetic circuit system 3 during elastic deformation, which would affect the acoustic performance of the sound-producing device 100.

Each yoke connecting portion 331 comprises avoidance holes 3311 penetrating therethrough at positions corresponding to the second connecting portion 42; wherein there are two spaced avoidance holes 3311 corresponding respectively to the first fixing portion 421 and the second fixing portion 422 of the second connecting portion 42. This design prevents the second connecting portion 42 of the elastic support member 4 from colliding with the yoke connecting portion 331 when the diaphragm 21 drives the elastic support member 4 to vibrate.

The sound-producing device 100 further comprises sealing covers 5 equal in number to the relief grooves 311.

Each sealing cover 5 comprises a seal body 51 and a limiting portion 52 formed by bending and extending from a side of the seal body 51 away from the main magnet 321 toward the diaphragm 21; the seal body 51 is disposed in the relief groove 311, the limiting portion 52 is fixed between adjacent auxiliary magnets 322; wherein the seal body 51 does not completely cover the relief groove 311, at least leaving the positions corresponding to the first connecting portion 41 or the second connecting portion 42 uncovered, to allow exposure of the first connecting portion 41 and the second connecting portion 42 of each elastic support member 4 for electrical connection with external devices. This design provides partial sealing protection for the grooves and relief grooves 311 through the sealing covers 5.

In this embodiment, the first connecting portion 41 is a metal connecting structure integrally formed with or connected to the first elastic portion 44, and the third connecting portion 43 is a metal connecting structure integrally formed with or connected to the second elastic portion 45.

Compared with the related technology, the sound-producing device 100 of the present invention places the elastic support members 4 between adjacent voice coils 22, and specifies that each elastic support member 4 includes a first connecting portion 41, a second connecting portion 42, a third connecting portion 43, a first elastic portion 44 and a second elastic portion 45; both the first elastic portion 44 and the second elastic portion 45 are U-shaped structures, and are respectively located between corresponding adjacent auxiliary magnets 322 and spaced from the auxiliary magnets 322. Through this three-dimensional structure of the elastic support member 4, connection can be maintained using elastic deformation of the three-dimensional structure during vibration, and during elastic deformation there is only internal strain force. Compared with planar elastic connecting structures, the stress is reduced, thereby greatly improving the service life of the elastic support member 4. Moreover, compared with planar elastic connecting structures, it significantly reduces the planar space occupied in the sound-producing device 100, providing extra space for installing other components, mainly providing more installation space for the magnetic circuit system 3, to enhance the acoustic performance of the sound-producing device 100. Meanwhile, adopting a multi-voice coil 22 structure can also improve the utilization efficiency of the magnetic circuit system 3, further enhancing the acoustic performance of the sound-producing device 100.

### Embodiment 2

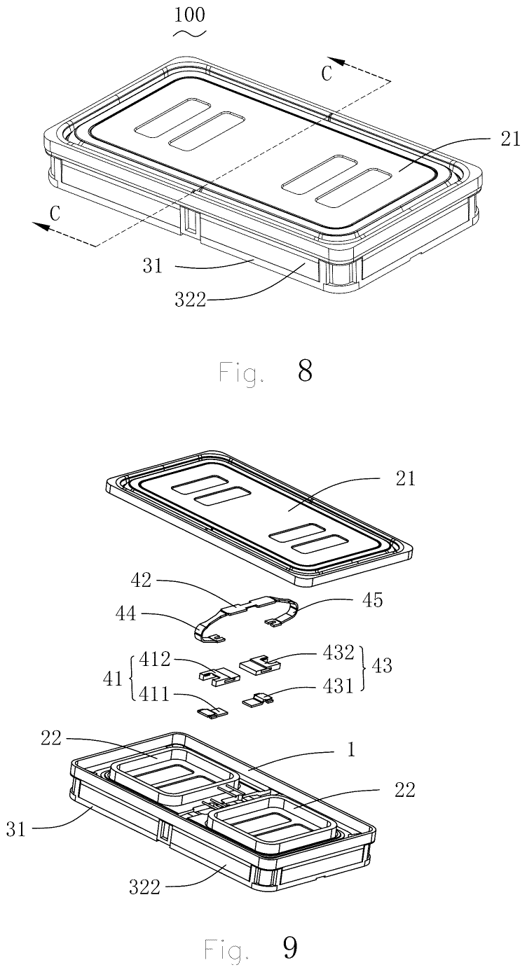

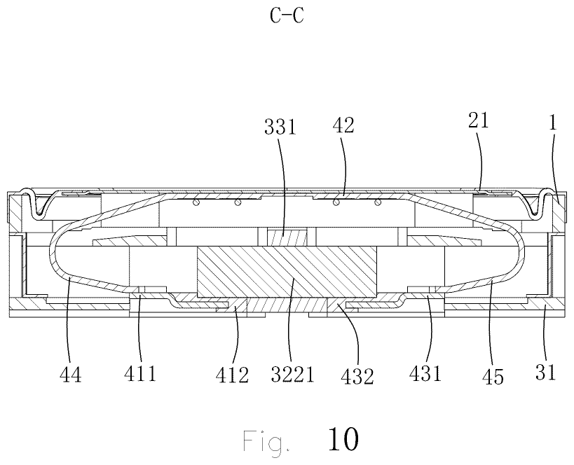

Different from Embodiment 1, referring to FIG. 7, in this embodiment, multiple voice coils 22 are arranged sequentially along the short axis direction of the frame 1. Since the sound-producing device 100 in this embodiment only differs from the sound-producing device 100 in Embodiment 1 in the arrangement direction of the voice coils 22, the sound-producing device 100 in this embodiment can achieve the same technical effects as the sound-producing device 100 in Embodiment 1, which will not be repeated here.

### Embodiment 3

Different from Embodiment 1, referring to FIGS. 8 and 10, the first connecting portion 41 of each elastic support member 4 comprises a first conductive member 411 fixed to an end of the first elastic portion 44 away from the second connecting portion 42 and a first plastic seal 412 injection-molded on the first conductive member 411 and fixed to the auxiliary magnet 322, the first conductive member 411 being electrically connected to the first elastic portion 44; the third connecting portion 43 of each elastic support member 4 comprises a second conductive member 431 fixed to an end of the second elastic portion 45 away from the second connecting portion 42 and a second plastic seal 432 injection-molded on the second conductive member 431 and fixed to the auxiliary magnet 322, the second conductive member 431 being electrically connected to the second elastic portion 45. This design prevents signal interference caused by direct contact between the first connecting portion 41 and the third connecting portion 43 with the lower yoke 31, and facilitates the connection of the voice coils 22 to external power sources through the first connecting portion 41 and the third connecting portion 43.

Since the sound-producing device 100 in this embodiment only differs from the sound-producing device 100 in Embodiment 1 in the first connecting portion 41 and the third connecting portion 43, the sound-producing device 100 in this embodiment can achieve the same technical effects as the sound-producing device 100 in Embodiment 1, which will not be repeated here.

The foregoing is merely illustrative of embodiments of the present invention, and it should be noted that modifications may be made to those skilled in the art without departing from the spirit of the invention but are intended to be within the scope of the inventio.

What is claimed is:

1. A sound-producing device, comprising:
a frame;
a vibration system comprising a diaphragm fixed to the frame and at least two spaced voice coils deployed to drive the diaphragm to vibrate and produce sound;
a magnetic circuit system comprising a lower yoke fixed to a side of the frame away from the vibration system and a magnet unit stacked and fixed to a side of the lower yoke close to the vibration system, wherein a number of the magnet units is equal to a number of the voice coils, each magnet unit comprising a main magnet and an auxiliary magnet surrounding and spaced from the main magnet to form a magnetic gap; each voice coil being inserted into one magnetic gap;
a plurality of elastic support members, with one elastic support member being disposed between each adjacent two voice coils; wherein
each elastic support member comprises a first connecting portion, a second connecting portion, a third connecting portion, a first elastic portion and a second elastic portion;
the first connecting portion and the second connecting portion are respectively located at opposite sides of the magnetic circuit system along a vibration direction of the vibration system, the third connecting portion and the first connecting portion are located at a same side of the magnetic circuit system and spaced apart from each other; the first connecting portion and the third connecting portion are respectively fixed to a side of corresponding auxiliary magnets away from the diaphragm, the second connecting portion is fixed to a side of the diaphragm close to the magnetic circuit system and electrically connected to the voice coils;
the first elastic portion and the second elastic portion are respectively located between corresponding adjacent auxiliary magnets and spaced from the auxiliary magnets, two ends of the first elastic portion are respectively fixed to the first connecting portion and the second connecting portion, two ends of the second elastic portion are respectively fixed to the third connecting portion and the second connecting portion;
the lower yoke comprises relief grooves penetrating therethrough at positions corresponding to the first connecting portion and the third connecting portion, such that the first connecting portion and the third connecting portion of each elastic support member are exposed.

2. The sound-producing device as described in claim 1, wherein the first elastic portion and the second elastic portion are both U-shaped structures, and the first elastic portion and the second elastic portion of each elastic support member have openings oriented facing each other.

3. The sound-producing device as described in claim 2, wherein the second connecting portion of each elastic support member comprises a first fixing portion connected to the first connecting portion, a second fixing portion connected to the third connecting portion, and a third fixing portion connecting the first fixing portion and the second fixing portion, both ends of one of the voice coils adjacent to the elastic support member are connected to the first fixing portion, both ends of another voice coil adjacent to the elastic support member are connected to the second fixing portion;
the first elastic portion of each elastic support member extends from the first connecting portion along the vibration direction by bending to the second connecting portion and forms a fixed connection with the second connecting portion, the second elastic portion of each elastic support member extends from the third connecting portion along the vibration direction by bending to the second connecting portion and forms a fixed connection with the second connecting portion.

4. The sound-producing device as described in claim 1, wherein the frame is rectangular; multiple voice coils are arranged sequentially along either a long axis direction or a short axis direction of the frame.

5. The sound-producing device as described in claim 1, wherein the auxiliary magnet of each magnet unit is ring-shaped, the auxiliary magnets of adjacent magnet units are spaced apart from each other; or,
the auxiliary magnets of adjacent magnet units are connected as an integral structure.

6. The sound-producing device as described in claim 1, wherein the auxiliary magnet of each magnet unit is ring-shaped, adjacent auxiliary magnets are connected as an integral structure through magnetic connecting portions; the first connecting portion and the third connecting portion of each elastic support member are respectively fixed to the magnetic connecting portions between corresponding adjacent auxiliary magnets.

7. The sound-producing device as described in claim 6, wherein the magnetic circuit system further comprises ring-shaped upper yokes equal in number to the auxiliary magnets, each upper yoke being stacked and fixed to a side of one auxiliary magnet close to the diaphragm; the first elastic portion and the second elastic portion of each elastic support member are respectively located between adjacent upper yokes and spaced from the adjacent upper yokes.

8. The sound-producing device as described in claim 7, wherein multiple upper yokes are spaced apart from each other; or,
multiple upper yokes are connected sequentially as an integral structure.

9. The sound-producing device as described in claim 7, wherein adjacent upper yokes are connected as an integral structure through magnetic yoke connecting portions; each yoke connecting portion comprises avoidance holes penetrating therethrough at positions corresponding to the second connecting portion.

10. The sound-producing device as described in claim 1, wherein the sound-producing device further comprises sealing covers equal in number to the relief grooves; each sealing cover comprises a seal body and a limiting portion formed by bending and extending from a side of the seal body away from the main magnet toward the diaphragm; the seal body is disposed in the relief groove, the limiting portion is fixed between adjacent auxiliary magnets.

11. The sound-producing device as described in claim 1, wherein the first connecting portion of each elastic support member comprises a first conductive member fixed to an end of the first elastic portion away from the second connecting portion and a first plastic seal injection-molded on the first conductive member and fixed to the auxiliary magnet, the first conductive member being electrically connected to the first elastic portion; the third connecting portion of each elastic support member comprises a second conductive member fixed to an end of the second elastic portion away from the second connecting portion and a second plastic seal injection-molded on the second conductive member and fixed to the auxiliary magnet, the second conductive member being electrically connected to the second elastic portion.
